(19) United States
(12) Patent Application Publication
(10) Pub. No.: US 2013/0250480 A1
(43) Pub. Date: Sep. 26, 2013

(54) MULTI-LAYER CERAMIC ELECTRONIC COMPONENT AND METHOD OF MANUFACTURING THE SAME

(71) Applicant: SAMSUNG ELECTRO-MECHANICS, Suwon (KR)

(72) Inventors: Chul Soon AHN, Suwon (KR); Jae Yeol CHOI, Suwon (KR); Jae Hyuk SHIM, Suwon (KR); Young Sook LEE, Suwon (KR); Hye Young CHOI, Suwon (KR); Eun Young NA, Suwon (KR)

(73) Assignee: SAMSUNG ELECTRO-MECHANICS, Suwon (KR)

(21) Appl. No.: 13/671,419

(22) Filed: Nov. 7, 2012

(30) Foreign Application Priority Data
Mar. 20, 2012 (KR) 10-2012-0028211

(51) Int. Cl. H01G 4/12

(52) U.S. Cl. CPC H01G 4/129
USPC 361/321.2; 156/89.12; 156/89.16; 156/89.17

(57) ABSTRACT

There is provided a multi-layer ceramic electronic component including: a ceramic sintered body in which a plurality of dielectric layers are laminated; first and second internal electrodes formed in the ceramic sintered body; first and second external electrodes formed on both ends of the ceramic sintered body while covering a circumference thereof, and electrically connected to the first and second internal electrodes; and a sealing part including a glass component and formed in a gap between an outer surface of the ceramic sintered body and ends of the first and second external electrodes.

### CROSS-REFERENCE TO RELATED APPLICATIONS

This application claims the priority of Korean Patent Application No. 10-2012-0028211 filed on Mar. 20, 2012, in the Korean Intellectual Property Office, the disclosure of which is incorporated herein by reference.

### BACKGROUND OF THE INVENTION

1. Field of the Invention

The present invention relates to a multi-layer ceramic electronic component and a method of manufacturing the same.

2. Description of the Related Art

A representative electronic component using a ceramic material may include, for example, a capacitor, an inductor, a piezoelectric element, a varistor, a thermistor, or the like.

Among ceramic electronic components, a multi-layer ceramic capacitor (MLCC) can be miniaturized, can have high capacity secured therein, and can be easily mounted.

The multi-layer ceramic capacitor is a chip type condenser that may be mounted on circuit boards of various electronic products, such as computers, personal digital assistants (PDAs), mobile phones, and the like, to store or discharge electricity, and has various sizes and layering amounts, according to the intended usage and capacity thereof.

Recently, the sub-miniaturization and super-capacitance of multi-layer ceramic capacitors used in electronic products have been required, as electronic products have been miniaturized.

Therefore, thicknesses of dielectric layers and internal electrodes may be reduced to facilitate the miniaturization of electronic products, and the multi-layering of a ceramic capacitor may be undertaken so as to allow super-capacitance to be implemented therein.

However, as an amount of multi-layered dielectric layers provided in a multi-layer ceramic capacitor is increased, a thickness of a cover layer and a margin area in a chip have been reduced. It is therefore important to appropriately control a size of an external electrode due to a structure of a multi-layer ceramic capacitor in which the thickness of the cover layer and the margin area in the chip are reduced.

That is, in the plating of the external electrodes, a plating solution may permeate into the chip due to the size of the external electrodes being excessively reduced so as to facilitate miniaturization and realize high capacitance, such that it may not be possible to prevent the plating solution from contacting the internal electrodes, thereby causing a degradation in product reliability.

### SUMMARY OF THE INVENTION

An aspect of the present invention provides a new method capable of effectively preventing a plating solution from permeating into a chip at the time of plating an external electrode without changing a size of the external electrode.

According to an aspect of the present invention, there is provided a multi-layer ceramic electronic component, including: a ceramic sintered body in which a plurality of dielectric layers are laminated; first and second internal electrodes formed in the ceramic sintered body; first and second external electrodes formed on both ends of the ceramic sintered body while covering a circumference thereof, and electrically connected to the first and second internal electrodes; and a sealing part including a glass component and formed in a gap between an outer surface of the ceramic sintered body and ends of the first and second external electrodes.

The first and second external electrodes may have silver (Ag) as a main component and have a glass component added thereto.

A content of the glass component of the first and second external electrodes may be 14 to 30 vol % for all compositions.

The glass component may be a glass frit.

A thickness of the sealing part may be 0.1 to 2.0 μm.

The multi-layer ceramic electronic component may further include a nickel (Ni) plating layer formed on the first and second external electrodes.

The multi-layer ceramic electronic component may further include a tin (Sn) plating layer formed on the nickel plating layer.

According to another aspect of the present invention, there is provided a method of manufacturing a multi-layer ceramic electronic component, the method including: forming first and second internal electrodes by applying a first conductive paste to at least one surface of first and second ceramic sheets; forming a laminate by alternately laminating a plurality of the first and second ceramic sheets on which the first and second internal electrodes are formed; forming a ceramic sintered body by firing the laminate; forming first and second external electrodes by applying a second conductive paste including a glass component to both ends of the ceramic sintered body so as to cover exposed surfaces of the first and second internal electrodes; and forming a sealing part in a gap between an outer surface of the ceramic sintered body and ends of the first and second external electrodes by firing the ceramic sintered body having the first and second external electrodes formed thereon and diffusing a part of the glass component included in the first and second external electrodes to the outside through the ends of the first and second external electrodes.

In the forming of the first and second external electrodes, the second conductive paste may have the glass component added thereto while having silver (Ag) as a main component.

In the forming of the first and second external electrodes, a content of the glass component of the second conductive paste may be 14 to 30 vol % for all compositions.

In the forming of the sealing part, a thickness of the sealing part may be 0.1 to 2.0 μm.

The method may further include plating the first and second external electrodes after the forming of the sealing part.

In the plating of the first and second external electrodes, at least one plating layer formed of at least one of nickel (Ni) and tin (Sn) may be formed on the first and second external electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a structure of a multi-layer ceramic capacitor according to an embodiment of the present invention;

FIG. 2 is a cross-sectional view of line A-A′ of FIG. 1; and

FIG. 3 is a schematic plan view showing main parts of a multi-layer ceramic capacitor according to an embodiment of the present invention.

### DETAILED DESCRIPTION OF THE EMBODIMENTS

Hereinafter, embodiments of the present invention will be described in detail with reference to the accompanying drawings so that they may be easily practiced by those skilled in the art to which the present invention pertains.

The embodiments of the present invention may be modified in many different forms and the scope of the invention should not be seen as being limited to the embodiments set forth herein.

Rather, these embodiments are provided so that this disclosure will be thorough and complete, and will fully convey the concept of the invention to those skilled in the art.

In the drawings, the shapes and dimensions of elements may be exaggerated for clarity, and the same reference numerals will be used throughout to designate the same or like components.

In addition, like reference numerals denote parts having similar functions and performing similar actions throughout the drawings.

In addition, unless explicitly described otherwise, “comprising” any components will be understood to imply the inclusion of other components without the exclusion of any other components.

The present invention relates to a ceramic electronic component. As the ceramic electronic component according to the embodiment of the present invention, there are a multi-layer ceramic capacitor, an inductor, a piezoelectric element, a varistor, a chip resistor, a thermistor, and the like. Hereinafter, a multi-layer ceramic capacitor will be described as an example of the ceramic electronic component.

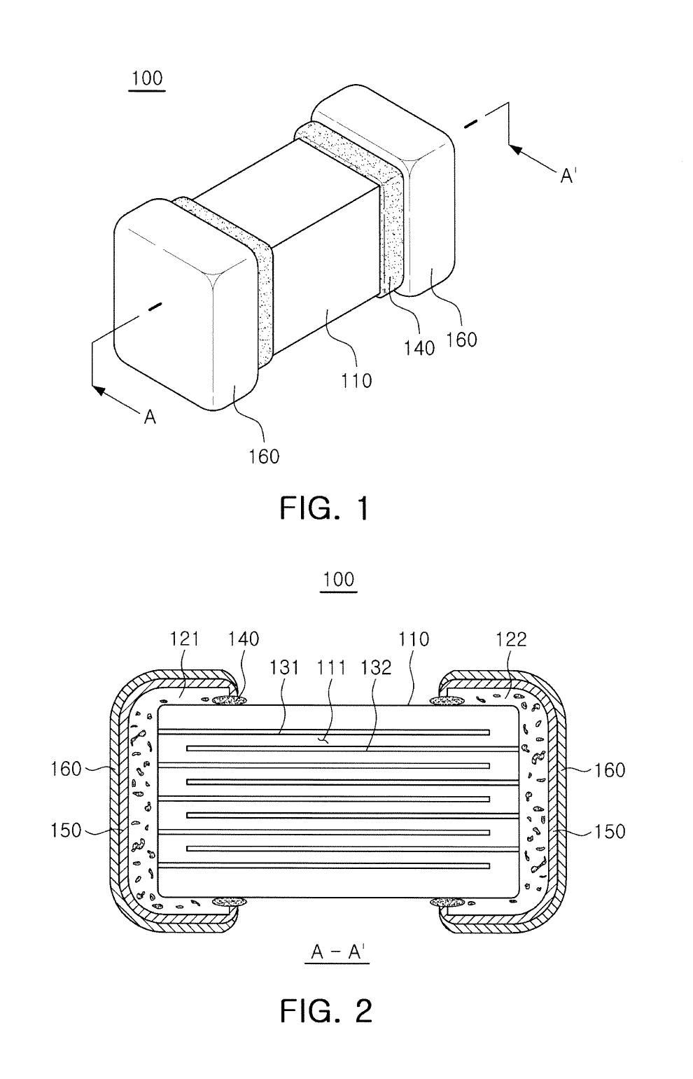

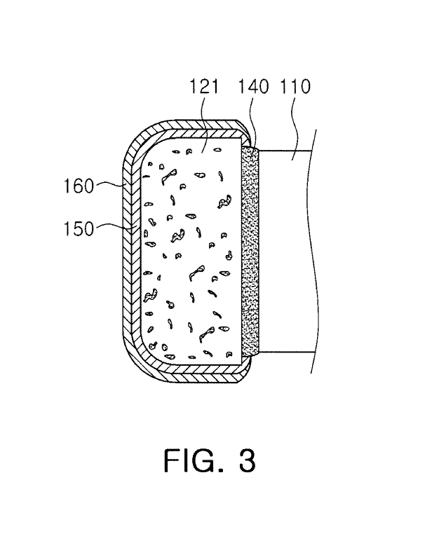

Referring to FIGS. 1 and 2, a multi-layer ceramic capacitor 100 according to an embodiment of the present invention includes a ceramic sintered body 110 in which a plurality of dielectric layers 111 are laminated, first and second internal electrodes 131 and 132 each formed on at least one surface of the dielectric layer 111 and provided in the ceramic sintered body 110, and first and second external electrodes 121 and 122 formed on both ends of the ceramic sintered body 10 while covering a circumference thereof.

In addition, a sealing part 140 is provided in a gap between an outer surface of the ceramic sintered body 111 and ends of the first and second external electrodes 121 and 122. Here, the sealing part 140 may include a glass component.

The ceramic sintered body 110 may be formed by stacking the plurality of dielectric layers 111.

In a state in which the plurality of dielectric layers 111 configuring the ceramic sintered body 110 are sintered, they may be integrated such that a boundary between adjacent dielectric layers may not be readily apparent.

In addition, a shape of the ceramic sintered body 110 is not particularly limited. Generally, the ceramic sintered body may have a rectangular parallelepiped shape.

In addition, dimensions of the ceramic sintered body 110 are not particularly limited. For example, the ceramic sintered body 110 may have a size of 0.6 mm×0.3 mm, or the like, such that the multi-layer ceramic capacitor 100 may be formed to have a relatively high capacitance of 1.0 μF or more.

In addition, if necessary, dielectric cover layers (not shown) having a predetermined thickness may be further formed on an outermost surface of the ceramic sintered body 110, that is, the top and bottom thereof based on FIG. 2.

The dielectric cover layer refers to a dielectric layer having no internal electrode thereon. If necessary, at least two dielectric cover layers may be vertically laminated, and thus, a thickness thereof can be controlled.

The dielectric layers 111 configuring the ceramic sintered body 110 may include a ceramic powder, for example, a BaTiO₃-based ceramic powder, or the like.

For example, the BaTiO₃-based ceramic powder may include (Ba₁₋ₓCaₓ)TiO₃, Ba(Ti_{1-y}Ca_{y})O₃, (Ba₁₋ₓCaₓ) (Ti_{1-y}Zr_{y})O₃, or Ba(Ti_{1-y}Zr_{y})O₃ in which, for example, Ca or Zr is partially dissolved in BaTiO₃, but is not limited thereto.

In addition, if necessary, the dielectric layer 111 may further include at least one of a transition metal oxide, a carbide, rare earth elements, ceramic additives such as magnesium (Mg), aluminum (Al), and the like, an organic solvent, a plasticizer, a binding agent, a dispersant, and the like, together with the ceramic powder.

In addition, the thickness of the dielectric layer 111 may be changed according to capacitance desired in the multi-layer ceramic capacitor 100.

The first and second internal electrodes 131 and 132 may be formed by printing internal electrode layers on ceramic green sheets forming the dielectric layers 111, using a first conductive paste by a printing method such as a screen printing method, a gravure printing method, or the like.

The ceramic sintered body 110 may be formed by alternately laminating and then firing the ceramic green sheets on which the internal electrode layers are printed. The capacitance of the multi-layer ceramic capacitor 100 is formed in an area in which the first and second internal electrodes 131 and 132 overlap.

In this case, the first conductive paste may include copper (Cu), nickel (Ni), palladium (Pd), an alloy of palladium-silver (Pd—Ag), and the like, all of which have excellent conductivity, but the embodiment of the present invention is not limited thereto.

Further, the first and second internal electrodes 131 and 132 are configured to have different polarities and may be alternately exposed through both ends of the ceramic sintered body 110 in a length direction of the ceramic sintered body 110.

The thickness of the first and second internal electrodes 131 and 132 may be determined according to intended usage. For example, the thickness of the first and second internal electrodes 131 and 132 may be set to be in a range between 0.2 and 1.0 μm in consideration of the size of the ceramic sintered body 110, but the present invention is not limited thereto.

The first and second external electrodes 121 and 122 are formed on both ends of the ceramic sintered body 110 while covering a circumference thereof and are electrically connected with the exposed portions of the first and second internal electrodes 131 and 132 so as to serve as external terminals.

The first and second external electrodes 121 and 122 may be made of conductive metals. For example, the first and second external electrodes 121 and 122 may include at least one of silver (Ag) and a silver (Ag) alloy having excellent conductivity as a main component and may include 14 to 30 vol % of a glass component for all the compositions.

In this case, the glass component may be, for example, a glass frit, or the like, but the present invention is not limited thereto.

Further, if necessary, the first and second external electrodes 121 and 122 may further include an organic vehicle, or the like, that is prepared in an organic solvent such as a base resin.

The sealing part 140 is formed in a gap between the outer surface of the ceramic sintered body 110 and the ends of the first and second external electrodes 121 and 122 and may include a glass component similar to that included in the first and second external electrodes 121 and 122.

That is, the glass component allows for sealing the gap between the outer surface of the ceramic sintered body 110 and the ends of the first and second external electrodes 121 and 122, thereby preventing a plating solution or moisture from permeating through the gap therebetween.

In this case, when the thickness of the sealing part 140 is insufficient, a certain amount of the plating solution may permeate into the ceramic sintered body 110, such that cracks, or the like, may be caused in the ceramic sintered body 110, the first and second internal electrodes 131 and 132, or the first and second external electrodes 121 and 122, which may be a cause of degradation in product reliability.

In order to solve the problems, the thickness of the sealing part 140 is controlled to be in a range of at least 0.1 to 2.0 μm. To this end, the glass component content included in the first and second external electrodes 121 and 122 may be controlled to 14 to 30 vol % as described above.

Therefore, the sealing part 140 may represent a compactness of 99% or more and permeability of the plating solution may be less than 1%, such that the permeation of the plating solution or moisture can be effectively prevented.

In addition, a first plating layer 150 formed of nickel (Ni) may be formed on the first and second external electrodes 121 and 122 and a second plating layer 160 formed of tin (Sn) may be further formed on the first plating layer 150.

The first and second plating layers 150 and 160 may serve to improve an electrical connection with a conductive land of a wiring substrate.

Hereinafter, a method of manufacturing a multi-layer ceramic capacitor according to an embodiment of the present invention will be described below.

First, a plurality of ceramic green sheets are prepared.

The ceramic green sheets are provided to form the dielectric layers 111 of the ceramic sintered body 110. In this case, a slurry prepared by mixing a ceramic powder, a polymer, and a solvent may be formed to be a sheet shape having a thickness of several μm by a doctor blade method or the like.

Next, first and second internal electrode layers are formed by printing a first conductive paste onto at least one surface of individual ceramic green sheets at a predetermined thickness of, for example, 0.2 to 1.0 μl.

The first conductive paste may include a metal powder formed of at least one of copper (Cu), nickel (Ni), palladium (Pd), and silver (Ag) and an alloy thereof, a ceramic powder, silica (SiO₂), and the like.

Any ceramic powder known to those skilled in the art may be used, but the embodiment of the present invention is not limited thereto. For example, a cellulose-based resin, an epoxy resin, an aryl resin, an acrylic resin, a phenol-formaldehyde resin, an unsaturated polyester resin, a polycarbonate resin, a polyamide resin, an alkyd resin, a rosin ester, and the like may be used.

In this case, the first internal electrode layer is exposed to one end of the first ceramic sheet and the second internal electrode layer is exposed to the other end of the second ceramic sheet.

As the method of printing the first conductive paste, a screen printing method, a gravure printing method, or the like may be used.

Next, a plurality of the first and second ceramic sheets having the first and second internal electrodes respectively formed thereon are alternately laminated, and a laminate is formed by pressing the laminated ceramic green sheets and the conductive paste formed on the ceramic green sheets in a lamination direction.

As a result, the ceramic laminate in which the ceramic green sheets and the conductive paste for internal electrodes are alternately laminated may be manufactured.

Here, at least one dielectric cover layer (not shown) may be further provided on the top and bottom of the laminate.

The dielectric cover layer may be formed of the same composition as that of the dielectric layer 111 disposed in the laminate. The dielectric cover layer is different from the dielectric layer 111, in that the dielectric cover layer does not include the internal electrode thereon.

Next, the laminate is formed as a chip type laminate by cutting the laminate to correspond to individual capacitors, and then, fired at a temperature of, for example, 1000° C. to 1300° C., thereby manufacturing the ceramic sintered body 110.

Then, the first and second external electrodes 121 and 122 may be formed by applying a second conductive paste, having a glass component added thereto while having a conductive metal as a main component, to both ends of the ceramic sintered body 110 so as to cover the exposed surfaces of the first and second internal electrode layers.

In this case, the first and second external electrodes 121 and 122 are electrically connected to each other through the exposed surfaces of the first and second internal electrode layers to serve as external terminals.

Further, the second conductive paste may further include an organic binder, a solvent, and the like, and as the glass component thereof, for example, a glass frit may be used.

That is, in the embodiment of the present invention, the first and second external electrodes 121 and 122 may be formed by sintering the slurry in which the conductive metal, the organic binder, the glass frit, and the organic solvent are mixed. In this case, the content of the glass frit may be 14 to 30 vol % for all the compositions.

The firing of the second conductive paste for the first and second external electrodes 121 and 122 may be performed at, for example, about 600° C. to 900° C.

The first and second external electrodes 121 and 122 are connected to the first and second internal electrodes by the firing of the second conductive paste.

In this process, the glass component excessively included in the first and second external electrodes 121 and 122 may be diffused through the ends of the first and second external electrodes 121 and 122, and thus, may form the sealing part 140 having a predetermined thickness by being disposed in the gap between the outer surface of the ceramic sintered body 110 and the ends of the first and second external electrodes 121 and 122.

In this case, the thickness of the sealing part 140 may be formed to be 0.1 to 2.0 μm so as to prevent a plating solution from permeating into the first or second internal electrode through the ceramic sintered body 110 at the time of a plating processing to be described below or prevent moisture from permeating into the first or second internal electrode via the same path.

In addition, the exposed part of the sealing part 140 may reach at least 2 μm or greater from the ends of the first and second external electrodes 121 and 122 so as to effectively prevent the moisture from permeating into the component body.

Next, the surfaces of the first and second external electrodes 121 and 122 are subjected to plating processing using metals such as copper (Cu), tin (Sn), or the like to form at least one plating layer (not shown), thereby completing the manufacturing of the multi-layer ceramic capacitor 100.

For example, the first plating layer 150 using copper (Cu) as a main component may be formed on the surfaces of the first and second external electrodes 121 and 122 and then, the second plating layer 160 using tin (Sn) as a main component may be formed on the first plating layer 150.

In this case, the forming of the plating layer may be performed using any one of an electroless plating method and an electroplating method.

As set forth above, according to embodiments of the present invention, a plating solution may be effectively prevented from permeating into a chip without changing the size of external electrodes by forming a sealing part including a glass component in gaps between an outer surface of a ceramic sintered body and ends of the external electrodes.

While the present invention has been shown and described in connection with the exemplary embodiments, it will be apparent to those skilled in the art that modifications and variations can be made without departing from the spirit and scope of the invention as defined by the appended claims.

What is claimed is:

1. A multi-layer ceramic electronic component, comprising:
a ceramic sintered body in which a plurality of dielectric layers are laminated;
first and second internal electrodes formed in the ceramic sintered body;
first and second external electrodes formed on both ends of the ceramic sintered body while covering a circumference thereof, and electrically connected to the first and second internal electrodes; and
a sealing part including a glass component and formed in a gap between an outer surface of the ceramic sintered body and ends of the first and second external electrodes.

2. The multi-layer ceramic electronic component of claim 1, wherein the first and second external electrodes have silver (Ag) as a main component and have a glass component added thereto.

3. The multi-layer ceramic electronic component of claim 2, wherein a content of the glass component of the first and second external electrodes is 14 to 30 vol % for all compositions.

4. The multi-layer ceramic electronic component of claim 2, wherein the glass component is a glass frit.

5. The multi-layer ceramic electronic component of claim 1, wherein a thickness of the sealing part is 0.1 to 2.0 μl.

6. The multi-layer ceramic electronic component of claim 1, further comprising a nickel (Ni) plating layer formed on the first and second external electrodes.

7. The multi-layer ceramic electronic component of claim 6, further comprising a tin (Sn) plating layer formed on the nickel plating layer.

8. A method of manufacturing a multi-layer ceramic electronic component, the method comprising:
forming first and second internal electrodes by applying a first conductive paste to at least one surface of first and second ceramic sheets;
forming a laminate by alternately laminating a plurality of the first and second ceramic sheets on which the first and second internal electrodes are formed;
forming a ceramic sintered body by firing the laminate;
forming first and second external electrodes by applying a second conductive paste including a glass component to both ends of the ceramic sintered body so as to cover exposed surfaces of the first and second internal electrodes; and
forming a sealing part in a gap between an outer surface of the ceramic sintered body and ends of the first and second external electrodes by firing the ceramic sintered body having the first and second external electrodes formed thereon and diffusing a part of the glass component included in the first and second external electrodes to the outside through the ends of the first and second external electrodes.

9. The method of claim 8, wherein, in the forming of the first and second external electrodes, the second conductive paste has the glass component added thereto while having silver (Ag) as a main component.

10. The method of claim 9, wherein, in the forming of the first and second external electrodes, a content of the glass component of the second conductive paste is 14 to 30 vol % for all compositions.

11. The method of claim 8, wherein, in the forming of the sealing part, a thickness of the sealing part is 0.1 to 2.0 μm.

12. The method of claim 8, further comprising plating the first and second external electrodes after the forming of the sealing part.

13. The method of claim 12, wherein, in the plating of the first and second external electrodes, at least one plating layer formed of at least one of nickel (Ni) and tin (Sn) is formed on the first and second external electrodes.
